(19) United States
(12) Patent Application Publication
(10) Pub. No.: US 2021/0278629 A1
(43) Pub. Date: Sep. 9, 2021

(54) IMAGE PICKUP APPARATUS, FOCUS CONTROL METHOD, AND PROGRAM

(71) Applicant: SONY CORPORATION, TOKYO (JP)

(72) Inventors: SHUTARO YOROZU, KANAGAWA (JP); MASANORI KASA, KANAGAWA (JP); HIDENORI KARASAWA, KANAGAWA (JP)

(21) Appl. No.: 16/340,745

(22) PCT Filed: Nov. 2, 2017
(86) PCT No.: PCT/JP2017/039693

§ 371 Date: Apr. 10, 2019

(30) Foreign Application Priority Data
Nov. 16, 2016 (JP) 2016-223118

(51) Int. Cl. G02B 7/28; G02B 7/08; G03B 3/10

(52) U.S. Cl. CPC G02B 7/28; G03B 3/10; G02B 7/08

(57) ABSTRACT

The present technology relates to an image pickup apparatus, a focus control method, and a program that are aimed at enabling an MF distance to be rapidly adjusted. An image pickup apparatus according to a first aspect of the present technology includes a lens section including a focus adjusting lens, a control section configured to drive the focus adjusting lens over a movable area, and an operation receiving section configured to receive an instruction operation for causing the control section to drive the focus adjusting lens, in which the operation receiving section distinctively receives a first instruction operation for moving the focus adjusting lens by a first number of steps within the movable area and a second instruction operation for moving the focus adjusting lens by a second number of steps more than the first number of steps within the movable area. The present technology is applicable to a digital camera.

### TECHNICAL FIELD

The present technology relates to an image pickup apparatus, a focus control method, and a program, and more particularly to an image pickup apparatus, a focus control method, and a program that are aimed at enabling focus to be rapidly achieved at the time of manual focusing.

### BACKGROUND ART

Conventionally, a large majority of image pickup apparatuses such as a digital still camera and a digital video camera incorporate an autofocus function (hereinafter, referred to as an AF function) for automatically adjusting focus. By contrast, a desire of performing an adjustment of focus by a user himself or herself without relying on the AF function is answered, and therefore even an image pickup apparatus capable of manual focus (hereinafter, referred to as an MF) has been used.

In an image pickup apparatus having a shape that a lens projects from a camera body like a single-lens reflex camera etc., for example, the user rotates a focus ring installed on the lens. Through the processing, a focus adjusting lens is driven and an adjustment of an MF distance (focus distance arbitrarily adjusted by the user by using the MF) is performed.

Further, in an image pickup apparatus in which a lens does not project from a camera body like a compact digital camera etc. and that is incapable of installing a focus ring on the lens, for example, the user presses a push button installed in a body or a touch panel superposed on a display that displays a button to thereby perform an adjustment of the MF distance (for example, refer to PTL 1).

### CITATION LIST

### Patent Literature

[PTL 1]

Japanese Patent Laid-open No. 2011-151728

### SUMMARY

### Technical Problem

Similarly to a conventional example described above, in the image pickup apparatus in which the adjustment of the MF distance is performed by an operation to the push button or touch panel installed in the body, focus may not be achieved rapidly.

The present technology has been made in view of such circumstances and is aimed at enabling an MF distance to be rapidly adjusted.

### Solution to Problem

An image pickup apparatus according to a first aspect of the present technology includes: a lens section including a focus adjusting lens; a control section configured to drive the focus adjusting lens over a movable area; and an operation receiving section configured to receive an instruction operation for causing the control section to drive the focus adjusting lens, in which the operation receiving section distinctively receives a first instruction operation for moving the focus adjusting lens by a first number of steps within the movable area and a second instruction operation for moving the focus adjusting lens by a second number of steps more than the first number of steps within the movable area.

The operation receiving section may distinctively receive, from a user, the first instruction operation for moving the focus adjusting lens by the first number of steps within the movable area and the second instruction operation for moving the focus adjusting lens to a preset position by the second number of steps more than the first number of steps within the movable area.

In a case in which the second instruction operation is received by the operation receiving section, the control section may move the focus adjusting lens to the preset position without relation to a movement direction of the focus adjusting lens.

In a case in which the second instruction operation is received by the operation receiving section, the control section may move the focus adjusting lens to a preset and different position in accordance with the movement direction of the focus adjusting lens.

The operation receiving section may have a plurality of push buttons installed in a housing of the image pickup apparatus.

The operation receiving section may have left/right buttons for inputting the first instruction operation and up/down buttons for inputting the second instruction operation, the left/right buttons and the up/down buttons being installed in the housing of the image pickup apparatus.

The operation receiving section may include an information processing apparatus in which a connection is established between the operation receiving section and the image pickup apparatus.

The operation receiving section may have a display of the information processing apparatus and a touch panel laminated on the display.

The operation receiving section may receive a touch operation to the touch panel as the first instruction operation and receive a long-press operation as the second instruction operation.

The operation receiving section may receive an operation to a first button displayed on the display as the first instruction operation and receive an operation to a second button different from the first button displayed on the display as the second instruction operation.

A focus control method according to a first aspect of the present technology is a focus control method of an image pickup apparatus including a lens section including a focus adjusting lens, a control section configured to drive the focus adjusting lens over a movable area, and an operation receiving section configured to receive an instruction operation for causing the control section to drive the focus adjusting lens. The focus control method includes distinctively receiving, by the operation receiving section, a first instruction operation for moving the focus adjusting lens by a first number of steps within the movable area and a second instruction operation for moving the focus adjusting lens by a second number of steps more than the first number of steps within the movable area; and moving, by the control section, in a case in which the first instruction operation is received by the operation receiving section, the focus adjusting lens by the first number of steps and moving, in a case in which the second instruction operation is received by the operation receiving section, the focus adjusting lens by the second number of steps.

In the first aspect of the present technology, there are distinctively received a first instruction operation for moving the focus adjusting lens by a first number of steps within the movable area and a second instruction operation for moving the focus adjusting lens by a second number of steps more than the first number of steps within the movable area. In a case in which the first instruction operation is received, the focus adjusting lens is moved by the first number of steps and in a case in which the second instruction operation is received, the focus adjusting lens is moved by the second number of steps.

A program according to a second aspect of the present technology causes an information processing apparatus to execute: distinctively receiving, from a user, a first instruction operation for moving a focus adjusting lens performed to an information processing apparatus by a first number of steps within a movable area, the first instruction operation including an instruction operation for causing an image pickup apparatus to move the focus adjusting lens included in the image pickup apparatus, and a second instruction operation for moving the focus adjusting lens by a second number of steps more than the first number of steps within the movable area; and instructing the information processing apparatus to transmit a command corresponding to the first and second instruction operations received from the user to the image pickup apparatus.

There may be distinctively received, from the user, the first instruction operation for moving the focus adjusting lens performed to the information processing apparatus by the first number of steps within the movable area and the second instruction operation for moving the focus adjusting lens to a preset position by the second number of steps more than the first number of steps within the movable area.

There may be received a user operation to a touch panel laminated on a display of the information processing apparatus.

There may be received a touch operation to the touch panel as the first instruction operation and there may be received a long-press operation as the second instruction operation.

There may be received an operation to a first button displayed on the display as the first instruction operation and there may be received an operation to a second button different from the first button displayed on the display as the second instruction operation.

In the second aspect of the present invention, there are distinctively received, from a user, a first instruction operation for moving a focus adjusting lens performed to an information processing apparatus by a first number of steps within a movable area, the first instruction operation including an instruction operation for causing an image pickup apparatus to move the focus adjusting lens included in the image pickup apparatus, and a second instruction operation for moving the focus adjusting lens by a second number of steps more than the first number of steps within the movable area; and there is instructed the information processing apparatus to transmit a command corresponding to the first and second instruction operations received from the user to the image pickup apparatus.

### Advantageous Effect of Invention

According to a first aspect of the present technology, it is possible to rapidly adjust an MF distance.

According to a second aspect of the present technology, it is possible to rapidly adjust an MF distance of an image pickup apparatus.

### [BRIEF DESCRIPTION OF DRAWINGS]

FIG. 1 is an appearance diagram of an image pickup apparatus to which the present technology is applied.

FIG. 2 is a block diagram illustrating a configuration example of the image pickup apparatus to which the present technology is applied.

FIG. 3 is a flowchart for describing MF processing using an operating section.

FIG. 4 is a diagram illustrating a display example of a menu screen.

FIG. 5 is a diagram illustrating a display example of a screen for setting a custom button.

FIG. 6 is a diagram illustrating a display example of an enlarged and displayed live view image.

FIG. 7 is a diagram illustrating a movement example of an MF distance corresponding to an operation of a user.

FIG. 8 is another diagram illustrating a movement example of the MF distance corresponding to an operation of the user.

FIG. 9 is still another diagram illustrating a movement example of the MF distance corresponding to an operation of the user.

FIG. 10 is a diagram illustrating a display example of the enlarged and displayed live view image.

FIG. 11 is a block diagram illustrating a configuration example of an information processing apparatus.

FIG. 12 is a flowchart for describing the MF processing using the information processing apparatus.

FIG. 13 is a diagram illustrating a display example of a screen of the information processing apparatus.

FIG. 14 is another diagram illustrating a display example of the screen of the information processing apparatus.

FIG. 15 is a diagram illustrating a modified example of an MF distance adjusting button.

### DESCRIPTION OF EMBODIMENTS

Hereinafter, a preferred mode (hereinafter, referred to as an embodiment) for carrying out the present technology will be described in detail with reference to the accompanying drawings.

<Regarding Image Pickup Apparatus according to Embodiment>

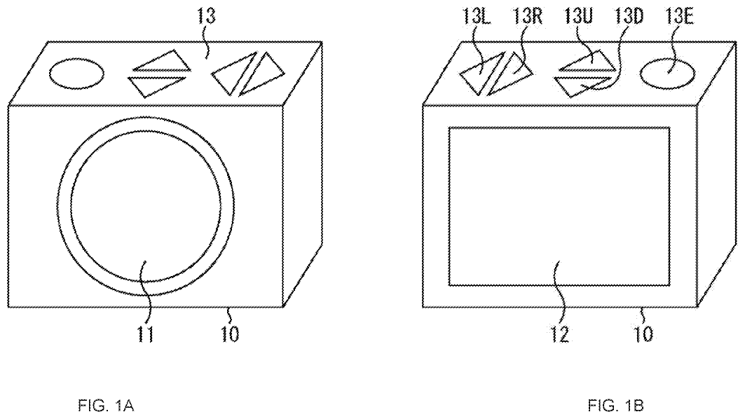

FIG. 1 is an appearance diagram of an image pickup apparatus according to an embodiment. FIG. 1A illustrates a case in which the image pickup apparatus is viewed from a front side and FIG. 1B illustrates a case in which the image pickup apparatus is viewed from a rear side.

As illustrated in FIG. 1A, the image pickup apparatus 10 has a lens section 11 on the front side of a housing. The lens section 11 has a focus adjusting lens, a drive section thereof, an aperture mechanism, and the like. In addition, the lens section 11 may have a zoom mechanism.

Further, as illustrated in FIG. 1B, the image pickup apparatus 10 includes a display section 12 including an LCD etc. on a rear face of the housing. The display section 12 displays a live view image for confirming a composition when capturing an image, a captured image, a reproduced image, or various setting screens.

As illustrated in FIGS. 1A and 1B, the image pickup apparatus 10 includes an operating section 13 including a plurality of push buttons on an upper face of the housing. The operating section 13 includes at least a left button 13L, a right button 13R, an up button 13U, a down button 13D, and an ENTER button 13E. Hereinafter, the left button 13L, the right button 13R, the up button 13U, and the down button 13D are referred to as even up/down/left/right buttons together. During an MF time, the up/down/left/right buttons are used to adjust a focus distance (It indicates a focal length adjusted owing to a position change of the focus adjusting lens driven in accordance with a received user operation. Hereinafter, it is referred to as an MF distance.) arbitrarily adjusted by a user by using the MF.

Note that an arrangement of the plurality of push buttons constituting the operating section 13 is not limited to the upper face of the housing, and further the plurality of push buttons may be arranged on the other faces. Further, the plurality of push buttons may be arranged in a distributed manner instead of being arranged on the same face of the housing. For example, the up/down/left/right buttons may be arranged on the rear face of the housing and the ENTER button 13E may be arranged on the upper face of the housing.

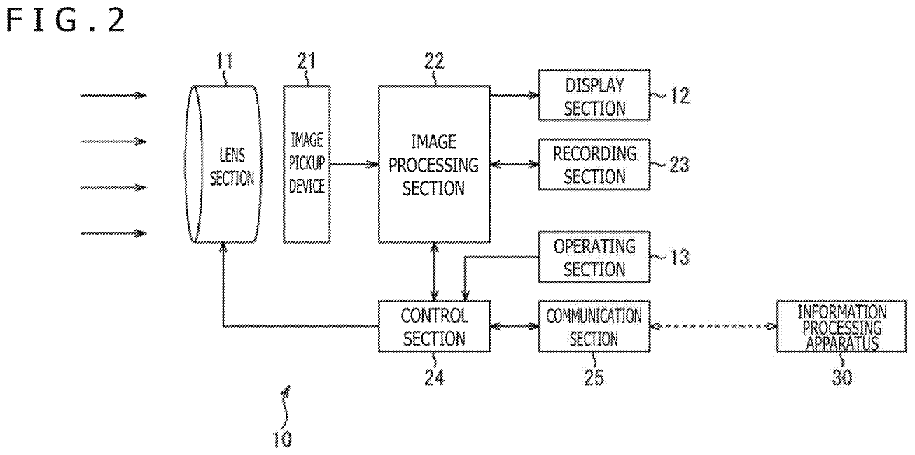

FIG. 2 is a block diagram illustrating a configuration example of the image pickup apparatus 10. The image pickup apparatus 10 includes the lens section 11, the display section 12, the operating section 13, an image pickup device 21, an image processing section 22, a recording section 23, a control section 24, and a communication section 25.

The lens section 11 collects light from a direction of a photographic object and makes the light incident on the image pickup device 21. The image pickup device 21 performs photoelectric conversion in accordance with incident light and outputs a pixel signal obtained in the result to the image processing section 22.

The image processing section 22 performs predetermined image processing on the pixel signal input from a previous stage and thereby generates the live view image to output it to the display section 12. Then, the image processing section 22 causes the display section 12 to display the live view image. Further, in accordance with a shutter operation from the user, the image processing section 22 performs the predetermined image processing on the pixel signal input from the previous stage and thereby generates a captured image (a still image or a moving image) to output it to the recording section 23. Then, the image processing section 22 causes the recording section 23 to record the captured image. Further, the image processing section 22 outputs a reproduced image (a still image or a moving image) input from the recording section 23 to the display section 12. Then, the image processing section 22 causes the display section 12 to display the reproduced image.

The recording section 23 records the captured image input from the image processing section 22 on a predetermined recording medium. Further, the recording section 23 reads an image recorded on the predetermined recording medium and outputs, as the reproduced image, it to the image processing section 22.

The control section 24 controls each section of the image pickup apparatus 10 in accordance with various operations from the user input by the operating section 13. In addition, the control section 24 controls each section of the image pickup apparatus 10 in accordance with various operations from the user using an information processing apparatus 30, which is input via the communication section 25.

Specifically, in accordance with the operation signal input from the operating section 13 in response to operations from the user, for example, the control section 24 controls a lens drive section of the lens section 11 to drive the focus adjusting lens. The process permits the user to adjust the MF distance.

The communication section 25 is connected to the information processing apparatus 30 through a wire (e.g., a USB cable etc.) or wirelessly (e.g., Wi-Fi, Bluetooth (any are registered trademarks), etc.) and communicates an image or an operation signal with the information processing apparatus 30. The communication section 25 may be an operation receiving section that receives an operational command generated by an operation of the user to the information processing apparatus 30 through a wire or wirelessly.

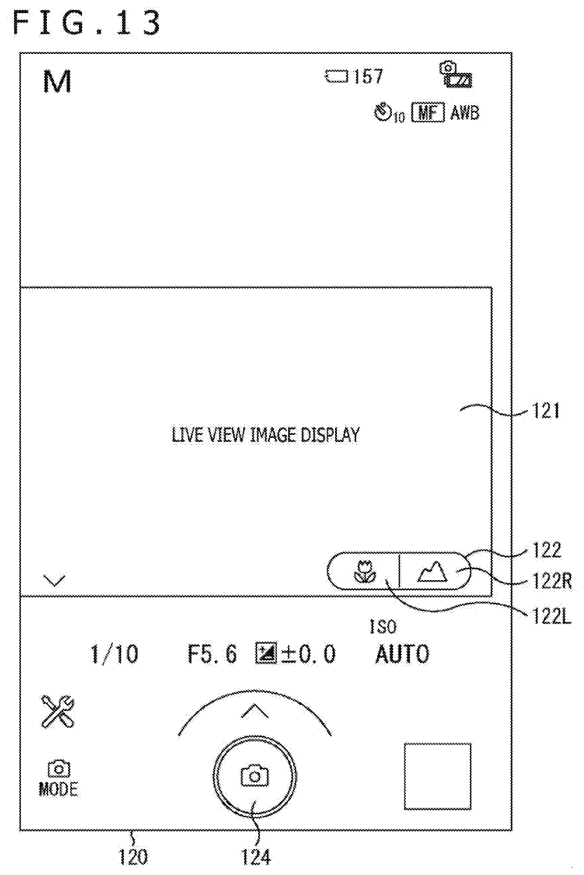

After being connected to the image pickup apparatus 10, the information processing apparatus 30 always and periodically acquires information (the live view image, the capturing distance, the capturing condition, and the like) indicative of a status from the image pickup apparatus 10 and displays the above information on a screen. In addition, the information processing apparatus 30 superposes MF distance adjusting buttons 122 (illustrated in FIG. 13) etc. on the live view image for display. Further, the information processing apparatus 30 transmits an operation signal in response to an operation of the user to the MF distance adjusting buttons 122 to the image pickup apparatus 10.

Note that the information processing apparatus 30 can be used for utility such that the information processing apparatus 30 is simultaneously connected to a plurality of the image pickup apparatuses 10 and controls the MF distances of the plurality of image pickup apparatuses 10 to be the same value simultaneously.

<MF Processing Using Operating Section 13>

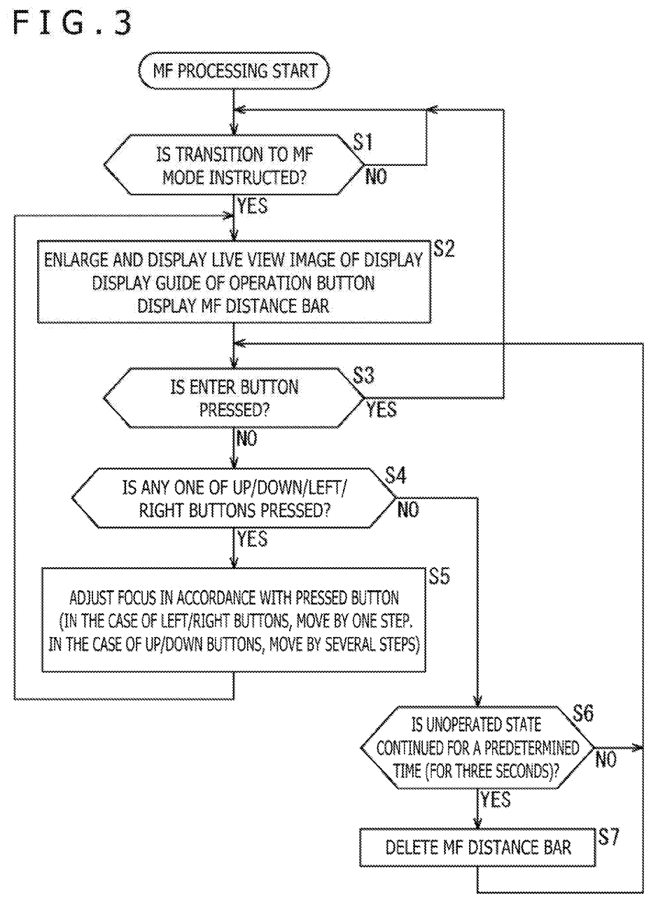

Next, FIG. 3 is a flowchart for describing the MF processing using the up/down/left/right buttons constituting the operating section 13 of the image pickup apparatus 10.

The MF processing is performed after the image pickup apparatus 10 is started up.

In step S1, it is determined whether or not a transition to an MF mode capable of an MF is instructed by a predetermined operation from the user. Then, until the transition to the MF mode is instructed, the image pickup apparatus 10 waits ready. At this time, the live view image (through image) for confirming the composition is displayed on the display section 12.

Note that, for example, a menu screen can be used or custom button setting capable of defining an arbitrary operation to an arbitrary push button can be used as an operation of the user for instructing the transition to the MF mode.

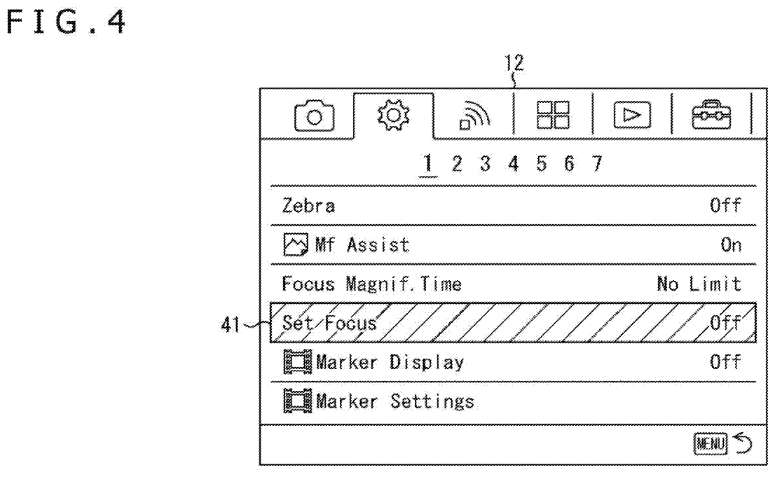

FIG. 4 illustrates a display example of the menu screen. The user can cause the display section 12 of the image pickup apparatus 10 to display the menu screen illustrated in FIG. 4 by using a predetermined operation. Further, the user can select a “Set Focus” 41 on the menu screen to thereby instruct the transition to the MF mode.

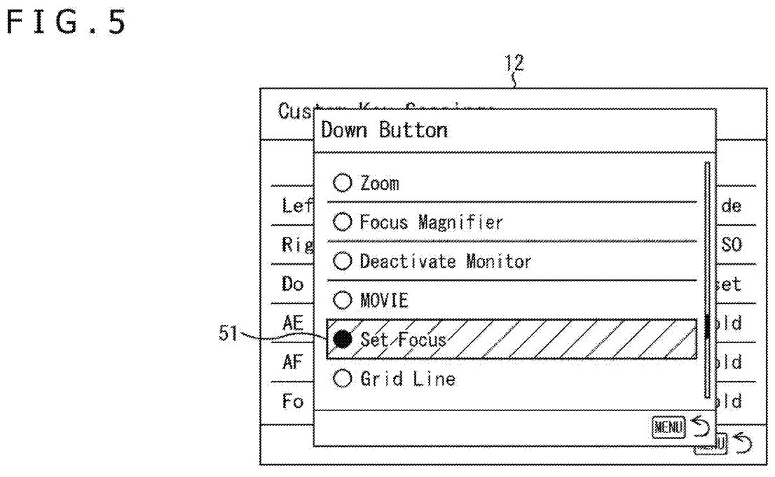

FIG. 5 illustrates a display example of a screen of the custom button setting for the down button 13D of the operating section 13.

By using a predetermined operation, the user can cause the display section 12 to display a screen of the custom button setting illustrated in FIG. 5 and define the transition to the MF mode to the down button 13D by selecting a “Set Focus” 51 on the screen. Then, the user presses the down button 13D in a state in which the transition to the MF mode is not performed to thereby instruct the transition to the MF mode.

Returning to FIG. 3, in step S1, in a case where it is determined that the transition to the MF mode is instructed by the user, the process proceeds to step S2. In step S2, a predetermined area of the live view image displayed on the display section 12 is enlarged.

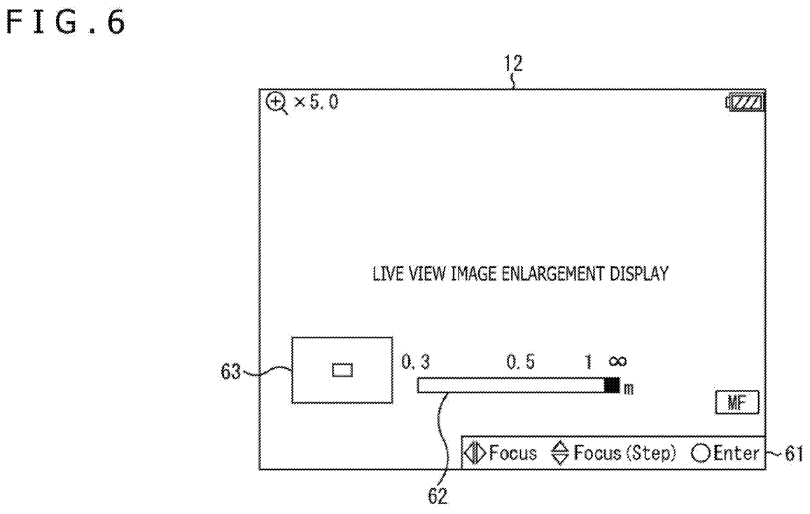

FIG. 6 illustrates a display example of the enlarged and displayed live view image. As illustrated in FIG. 6, a guide of an operation button 61, an MF distance bar 62, and an enlargement area display section 63 are further superposed and displayed on the enlarged and displayed live view image. Note that, with regard to a position of the enlarged area, a position at the center of the screen may be enlarged as illustrated in FIG. 6, any one of the positions in four corners of the screen may be enlarged, or a position corresponding to a principal photographic object detected by a well-known recognition technique may be enlarged.

The guide of an operation button 61 indicates an operation content through the up/down/left/right buttons and the ENTER button 13E. The up/down/left/right buttons are used for an adjustment operation of the MF distance. The ENTER button 13E is used for a decision operation of the MF distance.

The MF distance bar 62 indicates a present MF distance between a shortest MF distance and infinity. The enlargement area display section 63 indicates which area of the live view image is enlarged.

The live view image is enlarged and displayed, and thereby the user can easily adjust the MF distance. Further, the guide of an operation button 61 is displayed, and thereby the user can know a correspondence between the up/down/left/right buttons, etc. and an adjustment of the MF. Then, the MF distance bar 62 is displayed, and thereby the user can know the present MF distance. Further, the enlargement area display section 63 is displayed, and thereby the user can know which area of the live view image is enlarged.

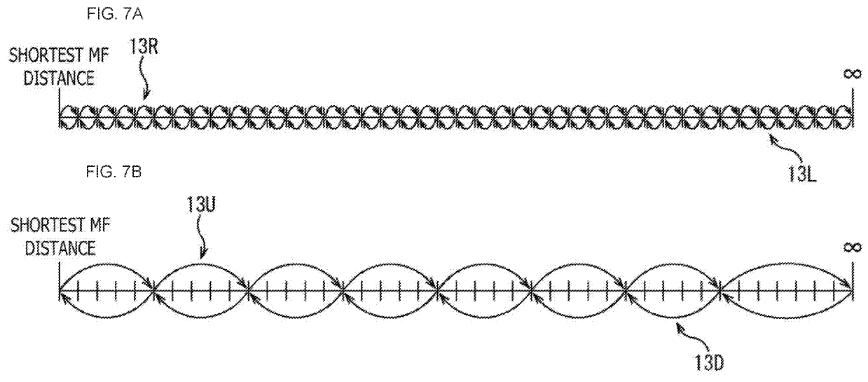

FIG. 7 illustrates a movement example of the MF distance corresponding to an operation to the up/down/left/right buttons when performing the MF processing. A “step” of the MF distance used for the following description is assumed to be a term for indicating one area obtained by dividing the movable area of the focus adjusting lens by a predetermined number. The movable area may be divided at equal intervals or at different intervals when divided by the predetermined number.

Specifically, as illustrated in FIG. 7A, whenever the right button 13R is pressed once, the MF distance is moved by one step in a direction of receding from the image pickup apparatus 10. Conversely, whenever the left button 13L is pressed once, the MF distance is moved by one step in a direction of approaching the image pickup apparatus 10. In other word, whenever the right button 13R is pressed once, a focus position of the photographic object is moved by one step in the direction of receding from the image pickup apparatus 10. Conversely, whenever the left button 13L is pressed once, the focus position of the photographic object is moved by one step in the direction of approaching the image pickup apparatus 10.

Further, as illustrated in FIG. 7B, whenever the up button 13U is pressed once, the MF distance is moved by several steps (a preset value equal to or more than two) in the direction of receding from the image pickup apparatus 10. Conversely, whenever the down button 13D is pressed once, the MF distance is moved by several steps (the preset value equal to or more than two) in the direction of approaching the image pickup apparatus 10.

Returning to FIG. 3, in step S3, it is determined whether or not the ENTER button 13E is pressed. In a case where the ENTER button 13E is not pressed, the process proceeds to step S4. In step S4, it is determined whether or not any one of the up/down/left/right buttons is pressed. In a case where it is determined that any one of the up/down/left/right buttons is pressed, the process proceeds to step S5.

In step S5, the MF distance is moved in accordance with the pressed button of the up/down/left/right buttons.

That is, in a case where the right button 13R is pressed, the MF distance is moved by one step in the direction of receding from the image pickup apparatus 10. Conversely, in a case where the left button 13L is pressed, the MF distance is moved by one step in the direction of approaching the image pickup apparatus 10.

Further, in a case where the up button 13U is pressed once, the MF distance is moved by the preset number of steps in the direction of receding from the image pickup apparatus 10. Conversely, in a case where the down button 13D is pressed once, the MF distance is moved by the preset number of steps in the direction of approaching the image pickup apparatus 10. Then, the process returns to step S2 and the subsequent processes are repeated.

Note that, in step S4, in a case where it is determined that none of the up/down/left/right buttons are pressed, the process proceeds to step S6. In step S6, it is determined whether or not an unoperated state (state in which the up/down/left/right buttons and the ENTER button 13E are not pressed) is continued for a predetermined time (e.g., for three seconds). In a case where the unoperated state is not continued for the predetermined time, the process returns to step S3 and the subsequent processes are repeated.

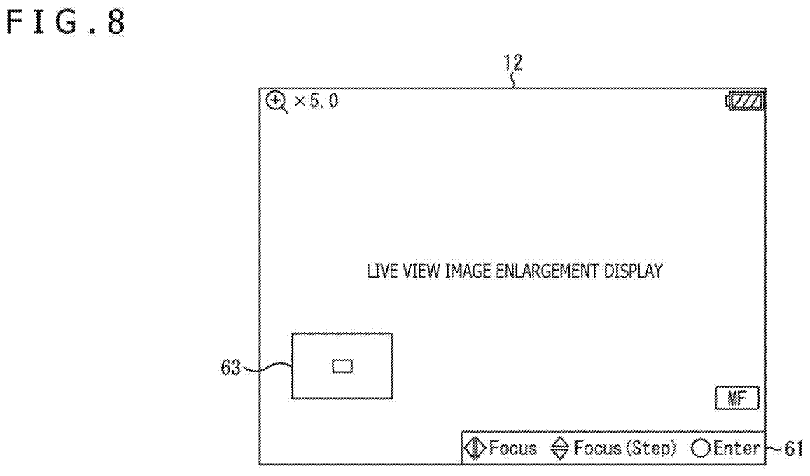

In step S6, in a case where it is determined that the unoperated state is continued for the predetermined time, the process proceeds to step S7. In step S7, as illustrated in FIG. 8, a superposed display of the MF distance bar 62 is deleted from the enlarged and displayed live view image. Then, the process returns to step S3 and the subsequent processes are repeated.

Then, in step S3, in a case where it is determined that the ENTER button 13E is pressed, the MF distance at the time is decided and the process returns to step S1. Then, the subsequent processes are repeated.

In accordance with the MF processing using the operating section described above, the user presses the up button 13U or the down button 13D to thereby move the MF distance largely. In addition, the user presses the right button 13R or the left button 13L to thereby adjust the MF distance delicately. Accordingly, the user can achieve focus rapidly and accurately by using the up/down/left/right buttons.

### Modified Example

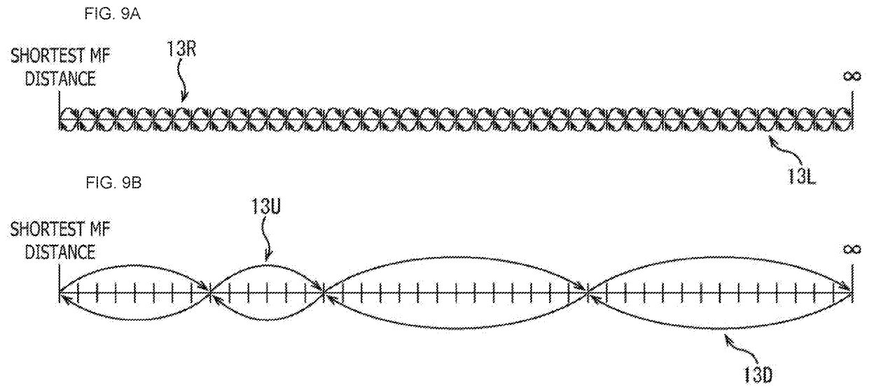

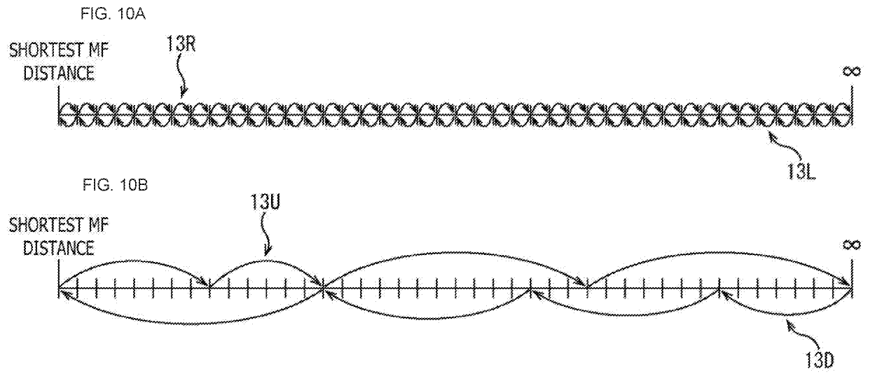

FIGS. 9 and 10 illustrate other movement examples of the MF distance corresponding to an operation to the up/down/left/right buttons when performing the MF processing.

In an example illustrated in FIG. 9, as illustrated in FIG. 9B, whenever the up button 13U is pressed once, the MF distance is moved to a preset position in the direction of receding from the image pickup apparatus 10. Conversely, whenever the down button 13D is pressed once, the MF distance is moved to the preset position (the same position as that in the direction of receding from the image pickup apparatus 10) in the direction of approaching the image pickup apparatus 10.

In an example illustrated in FIG. 10, as illustrated in FIG. 10B, whenever the up button 13U is pressed once, the MF distance is moved to a preset position in the direction of receding from the image pickup apparatus 10. Conversely, whenever the down button 13D is pressed once, the MF distance is moved to a preset position (position different from that in the direction of receding from the image pickup apparatus 10) in the direction of approaching the image pickup apparatus 10.

Note that a movement example of the MF distance corresponding to the operation to the up/down/left/right buttons when performing the MF processing is not limited to the examples illustrated in FIGS. 7, 9, and 10. The movement amount of the MF distance when the up button 13U or the down button 13D is operated is sufficient to be larger than the movement amount of the MF distance when the right button 13R or the left button 13L is operated

Further, in a case in which the right button 13R or the left button 13L is long pressed (a button operation in which a time at which a button is kept being pressed is longer than a time at which the button is pressed once), the MF distance may be moved in the same manner as in a case in which the up button 13U or the down button 13D is pressed as described above.

<Configuration Example of Information Processing Apparatus 30>

Next, the MF processing using the information processing apparatus 30 will be described.

The information processing apparatus 30 is assumed to be a smartphone, tablet-type computer, personal computer, or the like that is communicable with the image pickup apparatus 10 through a wire or wirelessly.

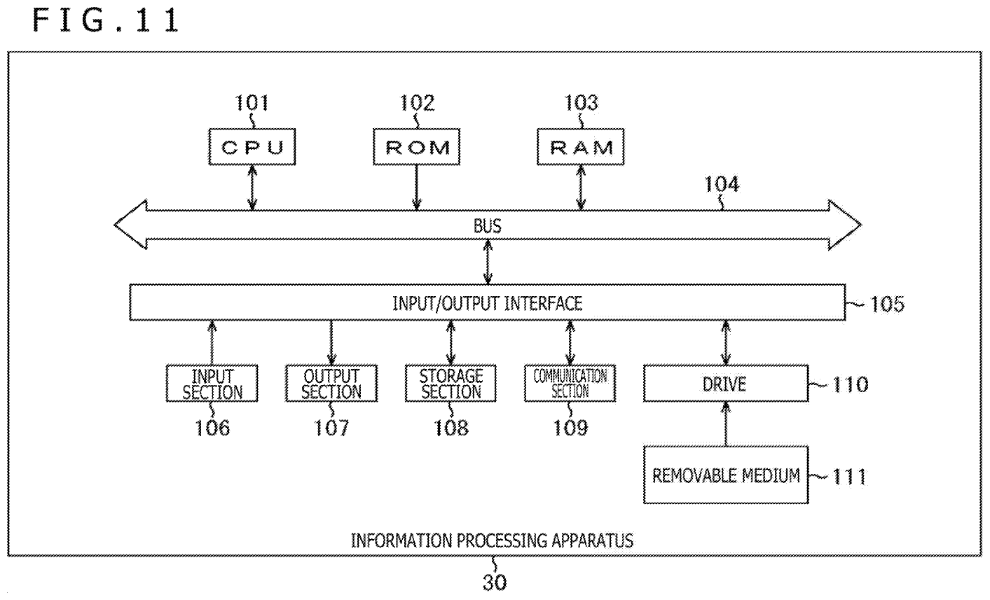

FIG. 11 is a block diagram illustrating a configuration example of the information processing apparatus 30.

In the information processing apparatus 30, a CPU (Central Processing Unit) 101, a ROM (Read Only Memory) 102, and a RAM (Random Access Memory) 103 are connected to one another by a bus 104.

An input/output interface 105 is further connected to the bus 104. An input section 106, an output section 107, a storage section 108, a communication section 109, and a drive 110 are connected to the input/output interface 105.

The input section 106 includes a touch panel, a microphone, or the like laminated on a display. The output section 107 includes a display, a speaker, or the like. The storage section 108 includes a nonvolatile memory or the like. The communication section 109 includes a network interface or the like and performs data communication with the image pickup apparatus 10. The drive 110 drives a removable medium 111 such as a semiconductor memory.

In the information processing apparatus 30 configured as described above, the CPU 101 loads a program that is installed, for example, in the storage section 108 onto the RAM 103 via the input/output interface 105 and the bus 104, and executes the program. Thus, the above-described series of processing is performed.

Programs executed by the information processing apparatus (CPU 101) may be provided being recorded in the removable medium 211 that is a packaged medium or the like, for example. Also, programs may be provided via a wired or wireless transmission medium, such as a local area network, the Internet or digital satellite broadcasting.

<MF Processing Using Information Processing Apparatus 30>

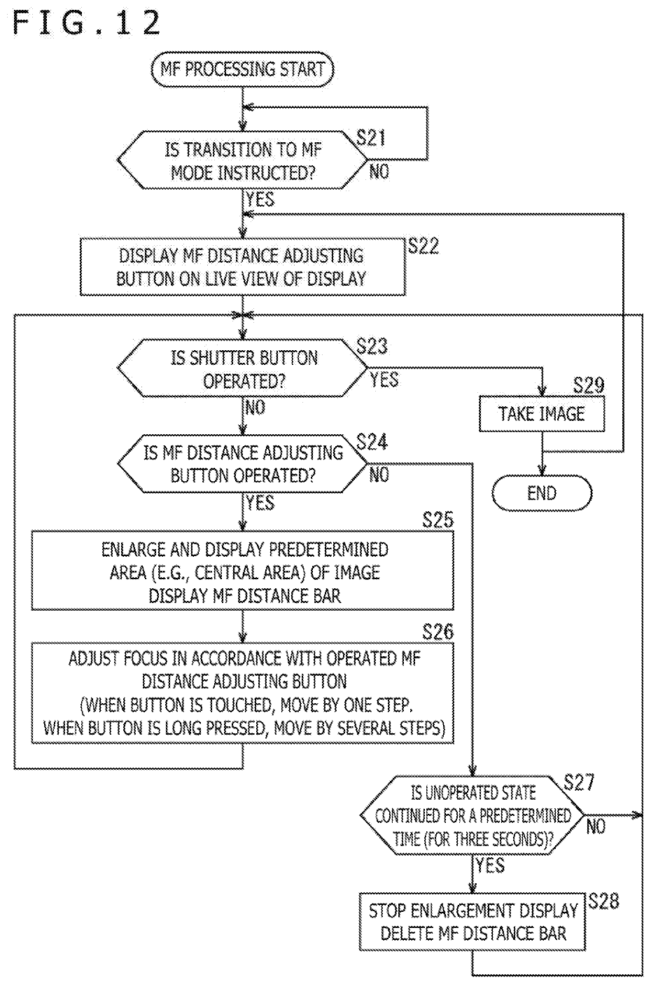

Next, FIG. 12 is a flowchart for describing the MF processing using the information processing apparatus 30 connected to the image pickup apparatus 10.

The MF processing is performed after a connection is established between the image pickup apparatus 10 and the information processing apparatus 30.

In step S21, the information processing apparatus 30 determines whether or not the transition to the MF mode capable of MF is instructed by using a predetermined operation from the user. Further, the information processing apparatus 30 waits ready until the transition to the MF mode is instructed. At this time, the live view image (through image) for confirming the composition is displayed on a display of the information processing apparatus 30.

In a case where it is determined that the transition to the MF mode is instructed by the user, the process proceeds to step S22. In step S22, the MF distance adjusting buttons 122 (illustrated in FIG. 13) are superposed and displayed on the live view image displayed on the display of the information processing apparatus 30.

FIG. 13 illustrates a display example of a screen displayed on the display of the information processing apparatus 30 in a state in which the connection is established between the information processing apparatus 30 and the image pickup apparatus 10.

The live view image 121 is displayed on the screen 120. Further, a shutter button 124 for performing a shutter operation is displayed on the screen 120. As described above, the MF distance adjusting buttons 122 are superposed and displayed on the live view image at the time of the MF mode.

The MF distance adjusting buttons 122 includes a left button 122L and a right button 122R. A case in which a touch panel is touched differs from a case in which the touch panel is long pressed (an operation in which the touch panel is continued to be pressed for a long period as compared with a case in which the touch panel is touched) in a movement width of the MF distance. Note that whenever the left button 122L or the right button 122R is operated, commands regarding an amount and direction for driving the focus adjusting lens of the image pickup apparatus are generated by the information processing apparatus. Then, the commands are transmitted to the communication section of the image pickup apparatus from a transmission section of the information processing apparatus. The image pickup apparatus receives the command regarding the operation and drives the focus adjusting lens.

Specifically, whenever the right button 122R is touched once, the MF distance is moved by one step in the direction of receding from the image pickup apparatus 10. Conversely, whenever the left button 122L is touched once, the MF distance is moved by one step in the direction of approaching the image pickup apparatus 10.

Further, whenever the right button 122R is long pressed once, the MF distance is moved by several steps (a preset value equal to or more than two) in the direction of receding from the image pickup apparatus 10. Conversely, whenever the left button 122L is long pressed once, the MF distance is moved by several steps in the direction of approaching the image pickup apparatus 10.

Returning to FIG. 12, in step S23, it is determined whether or not the shutter button 124 is operated. In a case where it is determined that the shutter button 124 is not operated, the process proceeds to step S24. In step S24, it is determined whether or not the left button 122L or right button 122R of the MF distance adjusting buttons 122 is operated (touched or long pressed). In a case where it is determined that either of the MF distance adjusting buttons 122 is operated, the process proceeds to step S25.

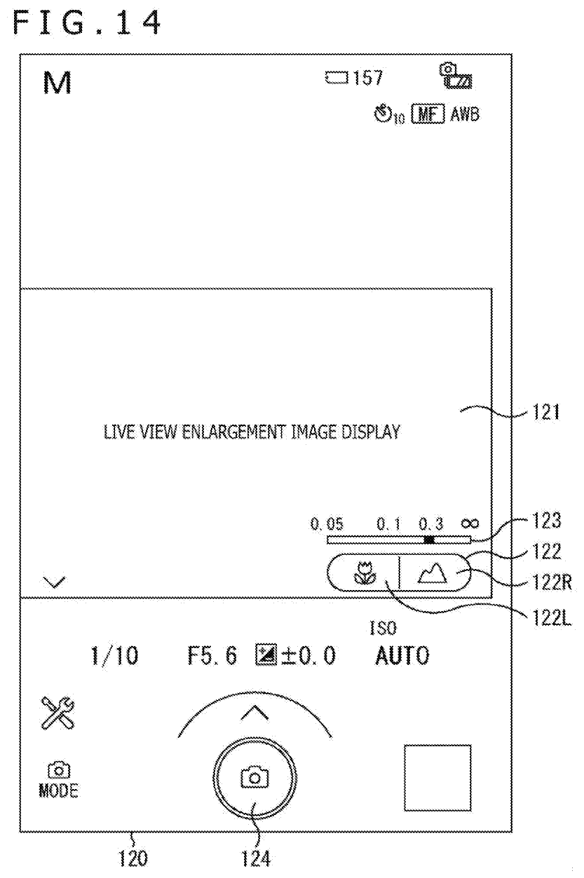

In step S25, as illustrated in FIG. 14, a predetermined area of the live view image displayed on the screen 120 of the display is enlarged. In addition to the MF distance adjusting buttons 122, the MF distance bar 123 is superposed and displayed on the enlarged and displayed live view image. The MF distance bar 123 indicates the present MF distance between the shortest MF distance and infinity.

In step S26, in the left button 122L or right button 122R of the MF distance adjusting buttons 122, the MF distance is moved in accordance with the operated button.

Specifically, in a case in which the right button 122R is touched, the MF distance is moved by one step in the direction of receding from the image pickup apparatus 10. Conversely, in a case in which the left button 122L is pressed, the MF distance is moved by one step in the direction of approaching the image pickup apparatus 10.

Further, in a case in which the right button 122R is long pressed, the MF distance is moved by the preset number of steps in the direction of receding from the image pickup apparatus 10. Conversely, in a case in which the left button 122L is long pressed, the MF distance is moved by the preset number of steps in the direction of approaching the image pickup apparatus 10. Then, the process returns to step S23 and the subsequent processes are repeated.

Note that, in step S24, in a case where it is determined that the left button 122L and right button 122R of the MF distance adjusting buttons 122 are not operated, the process proceeds to step S27. In step S27, it is determined whether or not an unoperated state (state in which the MF distance adjusting buttons 122 and the shutter button 124 are not operated) is continued for a predetermined time (e.g., for three seconds). In a case where it is determined that the unoperated state is not continued for the predetermined time, the process returns to step S23 and the subsequent processes are repeated.

In step S27, in a case where it is determined that the unoperated state is continued for the predetermined time, the process proceeds to step S28. In step S28, as illustrated in FIG. 13, an enlarged display of the live view image is returned to a normal display (display that is not enlarged), and simultaneously, a superposed display of the MF distance bar 123 is deleted from the live view image. Then, the process returns to step S23 and the subsequent processes are repeated.

Note that, in step S23, in a case where it is determined that the shutter button 124 is operated, the process proceeds to step S29. Further, images are captured by the image pickup apparatus 10 and then the process returns to the step S22.

In accordance with the MF processing using the information processing apparatus 30 described above, the user touches or long presses the MF distance adjusting buttons 122 displayed on a screen of the information processing apparatus 30. The process permits the user to move the MF distance largely or adjust the MF distance delicately. Accordingly, the user can achieve focus rapidly and accurately by using the MF distance adjusting buttons 122.

### Modified Example

The MF distance adjusting buttons 122 may be configured not by two buttons but by a number of buttons.

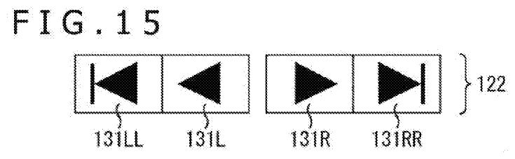

FIG. 15 illustrates a display example in a case in which the MF distance adjusting buttons 122 are configured by four buttons.

In a case of FIG. 15, the MF distance adjusting buttons 122 are configured by buttons 131LL, 131L, 131R, and 131RR.

Whenever the button 131LL is touched once, the MF distance is moved by several steps in the direction of approaching the image pickup apparatus 10. Whenever the button 131L is touched once, the MF distance is moved by one step in the direction of approaching the image pickup apparatus 10. Whenever the button 131R is touched once, the MF distance is moved by one step in the direction of receding from the image pickup apparatus 10. Whenever the button 131RR is touched once, the MF distance is moved by several steps (a preset value equal to or more than two) in the direction of receding from the image pickup apparatus 10.

Note that the buttons 131LL, 131L, 131R, and 131RR configuring the MF distance adjusting buttons 122 may be arranged in a cross direction in the same manner as in the up/down/left/right buttons of the operating section 13 described above.

Further, a movement of the MF distance corresponding to the operation to the MF distance adjusting buttons 122 is not limited to the above-described example. Various modifications may be performed in a similar manner as in the MF processing using the operating section 13.

In addition to the MF mode for performing focus adjustment by using a manual operation of the user, the image pickup apparatus 10 described above may have an AF mode in which the image pickup apparatus 10 automatically performs focus adjustment on the photographic object by using phase difference information or contrast information of the captured image. In addition, the MF mode and the AF mode may be constituted so as to be switched by a mode switching function of the image pickup apparatus 10.

In addition, the embodiment of the present technology is not limited to the above-described embodiment and can be variously modified without departing from the scope of the present technology.

The present technology can also take the following configuration.
(1)

An image pickup apparatus including:

a lens section including a focus adjusting lens;

a control section configured to drive the focus adjusting lens over a movable area; and

an operation receiving section configured to receive an instruction operation for causing the control section to drive the focus adjusting lens; in which

the operation receiving section distinctively receives a first instruction operation for moving the focus adjusting lens by a first number of steps within the movable area and a second instruction operation for moving the focus adjusting lens by a second number of steps more than the first number of steps within the movable area.
(2)

The image pickup apparatus according to (1), in which

the operation receiving section distinctively receives, from a user, the first instruction operation for moving the focus adjusting lens by the first number of steps within the movable area and the second instruction operation for moving the focus adjusting lens to a preset position by the second number of steps more than the first number of steps within the movable area.
(3)

The image pickup apparatus according to (1) or (2), in which

in a case in which the second instruction operation is received by the operation receiving section, the control section moves the focus adjusting lens to the preset position without relation to a movement direction of the focus adjusting lens.
(4)

The image pickup apparatus according to (1) or (2), in which

in a case in which the second instruction operation is received by the operation receiving section, the control section moves the focus adjusting lens to a preset and different position in accordance with the movement direction of the focus adjusting lens.
(5)

The image pickup apparatus according to any one of (1) to (4), in which

the operation receiving section has a plurality of push buttons installed in a housing of the image pickup apparatus.
(6)

The image pickup apparatus according to any one of (1) to (4), in which

the operation receiving section has left/right buttons for inputting the first instruction operation and up/down buttons for inputting the second instruction operation, the left/right buttons and the up/down buttons being installed in the housing of the image pickup apparatus.
(7)

The image pickup apparatus according to any one of (1) to (4), in which

the operation receiving section includes an information processing apparatus in which a connection is established between the operation receiving section and the image pickup apparatus.
(8)

The image pickup apparatus according to (7), in which

the operation receiving section has a display of the information processing apparatus and a touch panel laminated on the display.
(9)

The image pickup apparatus according to (8), in which

the operation receiving section receives a touch operation to the touch panel as the first instruction operation and receives a long-press operation as the second instruction operation.
(10)

The image pickup apparatus according to (8), in which

the operation receiving section receives an operation to a first button displayed on the display as the first instruction operation and receives an operation to a second button different from the first button displayed on the display as the second instruction operation.
(11)

A focus control method of an image pickup apparatus including

a lens section including a focus adjusting lens,

a control section configured to drive the focus adjusting lens over a movable area, and

an operation receiving section configured to receive an instruction operation for causing the control section to drive the focus adjusting lens, the focus control method including:

distinctively receiving, by the operation receiving section, a first instruction operation for moving the focus adjusting lens by a first number of steps within the movable area and a second instruction operation for moving the focus adjusting lens by a second number of steps more than the first number of steps within the movable area; and

moving, by the control section, in a case in which the first instruction operation is received by the operation receiving section, the focus adjusting lens by the first number of steps and moving, in a case in which the second instruction operation is received by the operation receiving section, the focus adjusting lens by the second number of steps.
(12)

A program for causing an information processing apparatus to execute:

distinctively receiving, from a user, a first instruction operation for moving a focus adjusting lens performed to an information processing apparatus by a first number of steps within a movable area, the first instruction operation including an instruction operation for causing an image pickup apparatus to move the focus adjusting lens included in the image pickup apparatus, and a second instruction operation for moving the focus adjusting lens by a second number of steps more than the first number of steps within the movable area; and

instructing the information processing apparatus to transmit a command corresponding to the first and second instruction operations received from the user to the image pickup apparatus.
(13)

The program according to (12) for causing an information processing apparatus to execute:

distinctively receiving, from the user, the first instruction operation for moving the focus adjusting lens performed to the information processing apparatus by the first number of steps within the movable area and the second instruction operation for moving the focus adjusting lens to a preset position by the second number of steps more than the first number of steps within the movable area.
(14)

The program according to (12) or (13) for causing an information processing apparatus to execute:

receiving a user operation to a touch panel laminated on a display of the information processing apparatus.
(15)

The program according to (14) for causing an information processing apparatus to execute:

receiving a touch operation to the touch panel as the first instruction operation and receiving a long-press operation as the second instruction operation.
(16)

The program according to (14) for causing an information processing apparatus to execute:

receiving an operation to a first button displayed on the display as the first instruction operation and receiving an operation to a second button different from the first button displayed on the display as the second instruction operation.

### REFERENCE SIGNS LIST

10 Image pickup apparatus, 11 Lens section, 12 Display section, 13 Operating section, 21 Image pickup device, 22 Image processing section, 23 Recording section, 24 Control section, 25 Communication section, 30 Information processing apparatus, 61 Guide of operation button, 62 MF distance bar, 63 Enlargement area display section, 101 CPU, 121 Live view image, 122 MF distance adjusting button, 123 MF distance bar, 124 Shutter button

1. An image pickup apparatus comprising:
a lens section including a focus adjusting lens;
a control section configured to drive the focus adjusting lens over a movable area; and
an operation receiving section configured to receive an instruction operation for causing the control section to drive the focus adjusting lens, wherein
the operation receiving section distinctively receives a first instruction operation for moving the focus adjusting lens by a first number of steps within the movable area and a second instruction operation for moving the focus adjusting lens by a second number of steps more than the first number of steps within the movable area.

2. The image pickup apparatus according to claim 1, wherein
the operation receiving section distinctively receives, from a user, the first instruction operation for moving the focus adjusting lens by the first number of steps within the movable area and the second instruction operation for moving the focus adjusting lens to a preset position by the second number of steps more than the first number of steps within the movable area.

3. The image pickup apparatus according to claim 2, wherein
in a case in which the second instruction operation is received by the operation receiving section, the control section moves the focus adjusting lens to the preset position without relation to a movement direction of the focus adjusting lens.

4. The image pickup apparatus according to claim 2, wherein
in a case in which the second instruction operation is received by the operation receiving section, the control section moves the focus adjusting lens to a preset and different position in accordance with the movement direction of the focus adjusting lens.

5. The image pickup apparatus according to claim 2, wherein
the operation receiving section has a plurality of push buttons installed in a housing of the image pickup apparatus.

6. The image pickup apparatus according to claim 5, wherein
the operation receiving section has left/right buttons for inputting the first instruction operation and up/down buttons for inputting the second instruction operation, the left/right buttons and the up/down buttons being installed in the housing of the image pickup apparatus.

7. The image pickup apparatus according to claim 2, wherein the operation receiving section includes an information processing apparatus in which a connection is established between the operation receiving section and the image pickup apparatus.

8. The image pickup apparatus according to claim 7, wherein
the operation receiving section has a display of the information processing apparatus and a touch panel laminated on the display.

9. The image pickup apparatus according to claim 8, wherein
the operation receiving section receives a touch operation to the touch panel as the first instruction operation and receives a long-press operation as the second instruction operation.

10. The image pickup apparatus according to claim 8, wherein
the operation receiving section receives an operation to a first button displayed on the display as the first instruction operation and receives an operation to a second button different from the first button displayed on the display as the second instruction operation.

11. A focus control method of an image pickup apparatus including
a lens section including a focus adjusting lens,
a control section configured to drive the focus adjusting lens over a movable area, and
an operation receiving section configured to receive an instruction operation for causing the control section to drive the focus adjusting lens, the focus control method comprising:
distinctively receiving, by the operation receiving section, a first instruction operation for moving the focus adjusting lens by a first number of steps within the movable area and a second instruction operation for moving the focus adjusting lens by a second number of steps more than the first number of steps within the movable area; and
moving, by the control section, in a case in which the first instruction operation is received by the operation receiving section, the focus adjusting lens by the first number of steps and moving, in a case in which the second instruction operation is received by the operation receiving section, the focus adjusting lens by the second number of steps.

12. A program for causing an information processing apparatus to execute:
distinctively receiving, from a user, a first instruction operation for moving a focus adjusting lens performed to an information processing apparatus by a first number of steps within a movable area, the first instruction operation including an instruction operation for causing an image pickup apparatus to move the focus adjusting lens included in the image pickup apparatus, and a second instruction operation for moving the focus adjusting lens by a second number of steps more than the first number of steps within the movable area; and
instructing the information processing apparatus to transmit a command corresponding to the first and second instruction operations received from the user to the image pickup apparatus.

13. The program according to claim 12 for causing an information processing apparatus to execute:
distinctively receiving, from the user, the first instruction operation for moving the focus adjusting lens performed to the information processing apparatus by the first number of steps within the movable area and the second instruction operation for moving the focus adjusting lens to a preset position by the second number of steps more than the first number of steps within the movable area.

14. The program according to claim 13 for causing an information processing apparatus to execute:
receiving a user operation to a touch panel laminated on a display of the information processing apparatus.

15. The program according to claim 14 for causing an information processing apparatus to execute:
receiving a touch operation to the touch panel as the first instruction operation and receiving a long-press operation as the second instruction operation.

16. The program according to claim 14 for causing an information processing apparatus to execute:
receiving an operation to a first button displayed on the display as the first instruction operation and receiving an operation to a second button different from the first button displayed on the display as the second instruction operation.
